(19) United States
(12) Patent Application Publication
(10) Pub. No.: US 2022/0351616 A1
(43) Pub. Date: Nov. 3, 2022

(54) SYSTEMS AND METHODS FOR ROUTE PLANNING BASED ON ROAD SAFETY METRICS

(71) Applicant: Verizon Patent and Licensing Inc., Basking Ridge, NJ (US)

(72) Inventors: Luca Kubin, Collecchio (IT); Alessio Sanfratello, Cerreto Guidi (FI) (IT); Xiaoxuan Zang, Boston, MA (US); Tommaso Mugnai, Figline e Incisa Valdarno (IT); Aurel Pjetri, Firenze (IT)

(73) Assignee: Verizon Patent and Licensing Inc., Basking Ridge, NJ (US)

(21) Appl. No.: 17/242,628

(22) Filed: Apr. 28, 2021

(51) Int. Cl. G08G 1/07; G01C 21/34; G08G 1/0969

(52) U.S. Cl. CPC G08G 1/07; G01C 21/3461; G08G 1/0969

(57) ABSTRACT

Embodiments described herein provide for the generation of models, which may predict or otherwise model road safety conditions. For example, embodiments may determine attributes of roads and/or segments of roads based on sensor data, statistical data, and/or other suitable data to determine road safety models associated with the roads or road segments. Such models may be used when determining navigation routes, controlling autonomous vehicles, city planning, and/or other suitable operations that may take road safety into account.

### BACKGROUND

Navigation systems, autonomous driving systems, and/or other systems may generate or provide navigation routes from starting points to destinations. Differing road conditions may present varying levels of risk with regard to road safety.

### BRIEF DESCRIPTION OF THE DRAWINGS

FIG. 1 illustrates an example overview of one or more embodiments described herein;

FIG. 2 illustrates an example user interface, via which one or more navigation routes may be provided in accordance with one or more embodiments;

FIG. 3 illustrates an example of segments of one or more roads;

FIG. 4 illustrates an example data structure representing safety scores associated with respective road segments, in accordance with one or more embodiments;

FIG. 5 illustrates an example safety model associated with a road segment, in accordance with one or more embodiments;

FIG. 6 illustrates an example of weighting a particular attribute based on another attribute, in accordance with one or more embodiments;

FIG. 7 illustrates an example process for generating safety scores for road segments and providing navigation instruction based on the generated safety scores, in accordance with some embodiments;

FIG. 8 illustrates an example environment in which one or more embodiments, described herein, may be implemented;

FIG. 9 illustrates an example arrangement of a radio access network (“RAN”), in accordance with some embodiments; and

FIG. 10 illustrates example components of one or more devices, in accordance with one or more embodiments described herein.

### DETAILED DESCRIPTION OF EXAMPLE EMBODIMENTS

The following detailed description refers to the accompanying drawings. The same reference numbers in different drawings may identify the same or similar elements.

Embodiments described herein provide for the generation of models, which may predict or otherwise model road safety conditions. In some embodiments, such models may be used when determining navigation routes, controlling autonomous vehicles, outputting alerts to drivers of vehicles, city planning, and/or other suitable operations that may take road safety into account. As a result, the safety afforded by navigation routes provided to users (e.g., in response to a request for navigation directions from a starting point to a destination), operations of an autonomous vehicle, operations of “smart” traffic fixtures (e.g., stoplights, street lights, configurable road signs, etc.), and/or other operations may be enhanced in accordance with embodiments described herein.

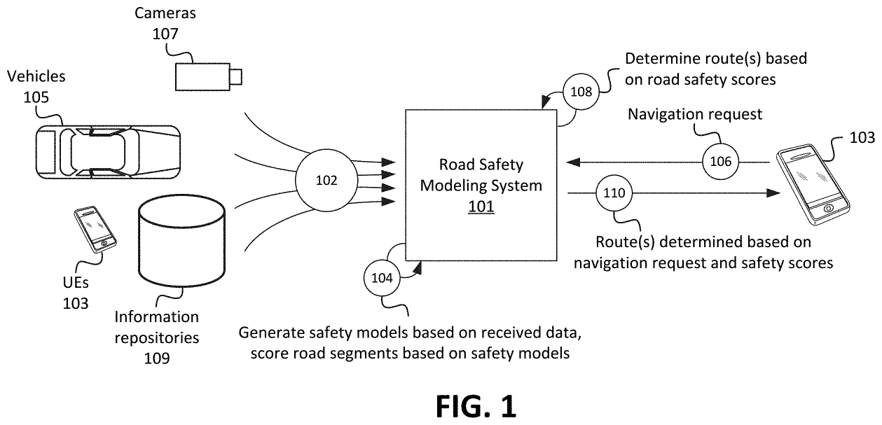

As shown in FIG. 1, for example, Road Safety Modeling System (“RSMS”) 101 may receive (at 102) data collected, measured, determined, and/or otherwise maintained by one or more sources. In some embodiments, such sources may include User Equipment (“UEs”) 103, vehicles 105, cameras 107, information repositories 109, and/or other sources. The received (at 102) data may include raw sensor data, such as data as collected or measured using accelerometers, gyroscopes, optical sensors such as cameras or other photosensors, Light Detection and Ranging (“LIDAR”) sensors, and/or other types of sensors. In some embodiments, the received (at 102) data may include processed and/or aggregated data, which may include classifications, extracted features, metadata, and/or other data derived from raw sensor data. In some embodiments, the received (at 102) data may include statistical data, such as crash data indicating a quantity and/or type of crashes at a given location or road, and/or data indicating the occurrence of other types of events. In some embodiments, the received (at 102) data may include correlation data, correlating the incidence of one or more crashes to other road features, conditions, events, etc. For example, the correlation data may indicate the presence of road bumps, slipperiness, and/or one or more other attributes that are present when one or more crashes occur. As discussed below, such correlation data may be used to identify attributes that are more likely to cause crashes, and such attributes may be more heavily weighted when generating a safety score for a given road or road segment.

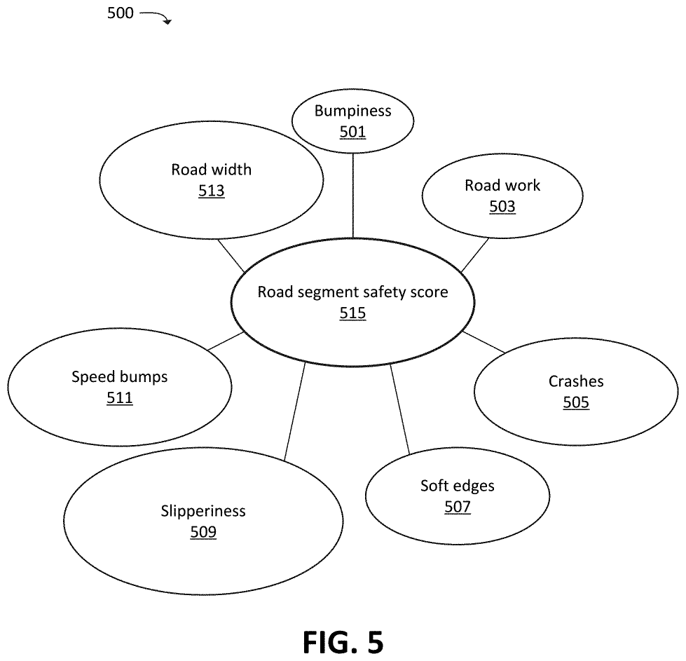

In some embodiments, RSMS 101 may receive (at 102) the data in an ongoing process, such that RSMS 101 is able to maintain up-to-date information based on which RSMS 101 may generate safety models and/or other operations described herein. In some embodiments, the data may be “pushed” by UEs 103, vehicles 105, cameras 107, information repositories 109, and/or other sources, which may include the data being provided by these sources without, or independent of, a specific request for such data from RSMS 101. In some embodiments, the data may be “pulled” by RSMS 101, which may include RSMS 101 polling or otherwise requesting the data from UEs 103, vehicles 105, cameras 107, information repositories 109, and/or other sources. In some embodiments, RSMS 101 and/or the data sources may implement an application programming interface (“API”), one or more applications, and/or may communicate via one or more other suitable communication pathways. Examples of such data that may be received (at 102) by RSMS 101 are described further below with respect to FIG. 5.

UEs 103 may include mobile telephones, tablet computers, Machine-to-Machine (“M2M”) devices, Internet of Things (“IoT”) devices, and/or other suitable devices that include sensors and/or communication capabilities. Vehicles 105 may include autonomous vehicles and/or other types of vehicles that include sensors and/or communication capabilities. In some embodiments, vehicles 105 may communicate with one or more networks via UEs 103 communicatively coupled to vehicles 105 (e.g., via Bluetooth, WiFi, Universal Serial Bus (“USB”), or other suitable communication pathways). In some embodiments, cameras 107 may include fixed and/or mobile cameras that are situated on, integrated in, or are pointed towards, roads and/or vehicles 105. Information repositories 109 may include one or more devices or systems (e.g., application servers, databases, cloud computing systems, etc.) that collect, generate, and/or otherwise maintain data, such as statistical data, regarding roads and/or vehicles 105. As one example, information repository 109 may include a database that provides information identifying quantities or other attributes of crashes or other incidents at particular roads or other locations.

RSMS 101 may generate (at 104) one or more safety models for one or more roads or road segments based on the received (at 102) data. For example, as discussed below, RSMS 101 may determine attributes such as bumpiness of roads, the presence of road work or construction zones, the incidence of crashes on particular roads or types of roads, soft edges (e.g., gravel edges, sloped edges, etc.), slipperiness of roads, the presence of speed bumps, width of roads, and/or other suitable attributes. The safety models may be based on such attributes, in some embodiments. As discussed below, safety models may vary with time, as certain attributes may be transitory. For example, a road may be slippery following rain, but the same road may not be slippery in the absence of rain.

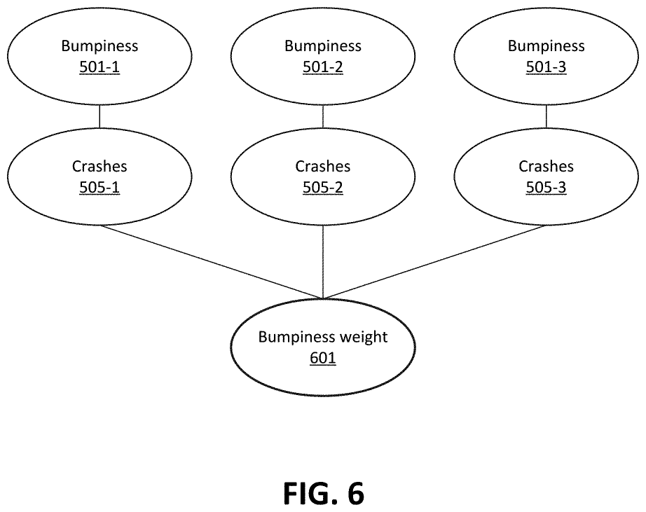

RSMS 101 may further score (at 104) respective road segments based on attributes identified with respect to such road segments. For example, a road safety score for a given road segment may be relatively high (e.g., indicating a high measure of safety) if the road is not bumpy, does not have road work present, is associated with relatively few crashes, does not have soft edges, is not slippery, does not have speed bumps, and/or is relatively wide. On the other hand, a road safety score for a given road may be relatively low (e.g., indicating a low measure of safety) if the road is bumpy, has road work present, is associated with a relatively large number of crashes, has soft edges, is slippery, has speed bumps, and/or is relatively narrow. Further examples of determining road safety scores are provided below with respect to FIGS. 5 and 6.

As noted above, RSMS 101 may use the generated (at 104) safety models and/or safety scores associated to enhance the safety of navigation instructions, automated smart fixtures, autonomous vehicle control, and/or other operations. For example, if a road segment is associated with a relatively low safety score, RSMS 101 may output instructions to a traffic signal to modify traffic signal timings (e.g., increase or decrease the amount of time that the traffic signal displays a red light, a green light, and/or a yellow light), may modify the wording displayed on a configurable road sign (e.g., “Warning! Slippery road!”), or the like. As another example, if a road segment is associated with a relatively low safety score, RSMS 101 may output instructions to autonomous vehicles traveling on or toward the road segment, and/or to a device or system that communicates with such vehicles, to reduce speed and/or increase distance between vehicles when traveling on the road segment. In some embodiments, different attributes leading to reduced safety scores may be associated with different remedial actions.

As another example, as shown in FIG. 1, RSMS 101 may receive (at 106) a navigation request from a particular UE 103. For example, a user of UE 103 may input a request for navigation directions from a starting point to a destination. While UE 103 is shown in FIG. 1 as a mobile phone, in practice, RSMS 101 may receive (at 106) a navigation request from a different type of UE, from a particular vehicle 105 (e.g., an infotainment or navigation system integrated in vehicle 105), and/or some other suitable source.

RSMS 101 may further determine one or more navigation routes based on the navigation request. For example, in accordance with embodiments described herein, RSMS 101 may utilize the generated (at 104) safety models and/or safety scores to determine an optimal route based on route safety and/or one or more other considerations, such as travel time, the presence of tolls, and/or other factors. RSMS 101 may further output (at 110) the determined route(s) to UE 103, after which a user of UE 103 may select a particular route (e.g., when multiple options are provided) and/or may initiate the requested route. While described herein as being performed by RSMS 101, in some embodiments, the determination of navigation routes may be performed in whole or in part by one or more other devices or systems that are communicatively coupled to RSMS 101. In such embodiments, RSMS 101 may provide safety scores associated with one or more roads or road segments, and the one or more other devices or systems may determine navigation routes based on the safety scores and one or more other factors.

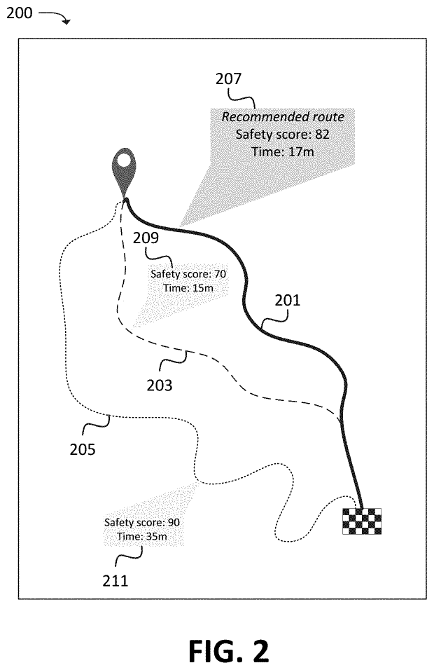

FIG. 2 illustrates an example user interface 200, via which UE 103 may present one or more routes as provided (e.g., at 110) by RSMS 101. For example, as shown, user interface 200 may include routes 201, 203, and 205, from a particular starting point to a particular destination. For example, RSMS 101 may identify one particular route as a recommended route, based on balancing factors such as the safety score for the route, a travel time associated with the route, and/or other factors. In this example, route 201 may be identified as the recommended route (e.g., in favor of routes 203 and 205) based on having a relatively high safety score and a relatively low travel time. For example, while route 203 may be associated with a lower travel time than route 201, the safety score of route 203 may be relatively low, and route 201 may be selected by RSMS 101 in favor of route 203 based on the respective travel times and safety scores of routes 201 and 203. Similarly, while route 205 may be associated with a higher safety score than route 201, the travel time of route 205 may be relatively high, and route 201 may be selected by RSMS 101 in favor of route 205 based on the respective travel times and safety scores of routes 201 and 205.

In some embodiments, when selecting routes to present to UE 103, RSMS 101 may select routes with the highest identified safety score, the lowest identified travel time, and/or one or more routes that have been identified based on both the safety score and the travel time (and/or one or more other factors). In some embodiments, RSMS 101 may only present a single navigation route, such as a navigation route that has been selected based on safety score and travel time and/or one or more other factors.

As further shown, user interface 200 may include information popups 207, 209, and 211 respectively associated with routes 201, 203, and 205. Information popups 207, 209, and 211 may include information regarding a respective route, such as a safety score, travel time, and/or other suitable information. As shown, information popup 207, associated with recommended route 201, may be displayed in a more prominent fashion than information popups 209 and 211, respectively associated with routes 203 and 205. For example, information popup 207 may be larger, may include larger text, may be a different color, and/or may otherwise be visually distinct from information popups 209 and 211. Additionally, or alternatively, route 201 may be displayed differently from routes 203 and 205, such as with a darker line, a solid line (where routes 203 and 205 are displayed with dashed lines), and/or some other sort of differentiator. A user of UE 103 may thus be able to easily distinguish which route has been indicated as a recommended route, based on safety considerations as well as other considerations.

The safety score of a given route may be based on safety scores associated with segments of roads that the route traverses. For example, as discussed below, RSMS 101 may identify safety scores for particular road segments based on attributes of the road segments. The safety score of the route may be an aggregate or derivation of the safety scores of the segments of which the route consists, such as a sum, average, median, or other computed value based on the safety scores of the road segments associated with the route.

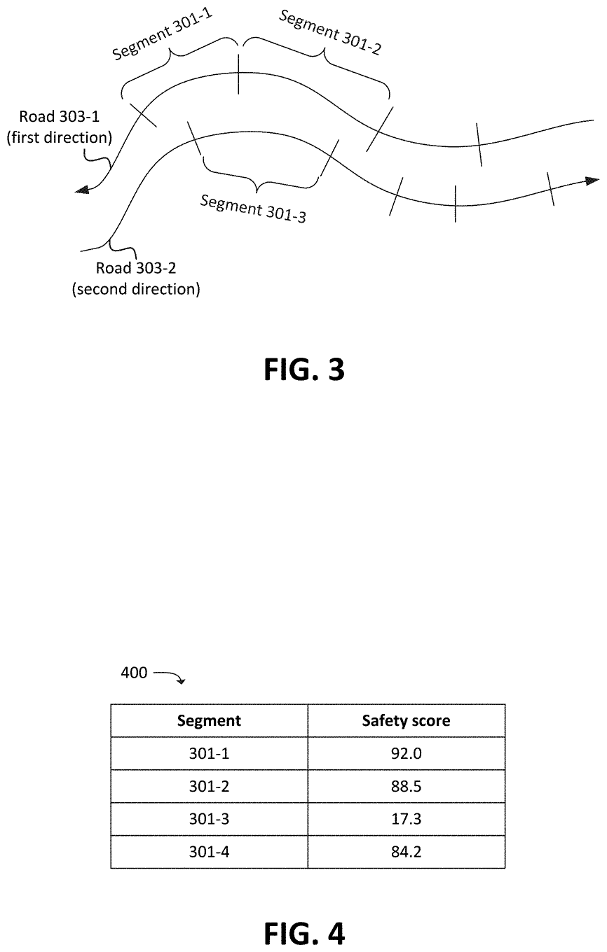

FIG. 3 illustrates an example of segments 301 of one or more roads 303. For example, a particular road 303 may include road segments 301. Further a particular road 303 may include multiple directions associated with different flows of vehicular traffic. As shown in FIG. 3, road 303-1 may correspond to a first direction of travel associated with road 303, and road 303-2 may correspond to a second (e.g., opposing) direction of travel associated with road 303. Road segments 301 may be segments of road 303, and road 303 may further be segmented according to different directions of travel. For example, road 303-1 may be associated with a first set of segments (e.g., including segments 301-1 and 301-2), and road 303-2 may be associated with a second set of segments (e.g., including segment 301-3 and/or other segments).

In some embodiments, RSMS 101 may determine safety scores and/or other attributes for a given road 303 on the basis of segments 301 of road 303. For example, as shown in FIG. 4, data structure 400 may indicate safety scores for different segments 301 of road 303. For example, road segment 301-1 may be associated with a respective safety score (i.e., 92.0 in this example), road segment 301-2 may be associated with a respective safety score (i.e., 88.5 in this example), and so on.

For example, RSMS 101 may generate one or more models associated with each respective road segment 301, and generate the safety scores for respective road segments 301 based on the models. The models may include, represent, and/or otherwise be based on attributes or other features associated with respective road segments 301. FIG. 5 illustrates example model 500, which may include, represent, and/or be based on bumpiness attribute 501, road work attribute 503, crash attribute 505, soft edges attribute 507, slipperiness attribute 509, speed bump attribute 511, and road width attribute 513. In some embodiments, model 500 may be based on additional attributes, fewer attributes, and/or different attributes. In some embodiments, safety model 500 may include road segment safety score 515, and/or road segment safety score 515 may be determined for a given road segment 301 based on the attributes associated with safety model 500. As noted above, the attributes of a given road segment 301 may be based on sensor data received from devices or systems that have measured such sensor data while located on (e.g., traveling on) road segment 301, and/or which otherwise are capable of collecting or measuring such sensor data (e.g., cameras pointed at road segment 301). As also noted above, the attributes of road segment 301 may be based on statistical data received from one or more information repositories 109 or other sources that aggregate, collect, etc. such data.

As denoted in the figure by ovals of varying sizes, different attributes may be weighted differently when generating road segment safety score 515 for a particular road segment 301. For example, a particular attribute (such as slipperiness attribute 509) with a larger oval may be weighted more heavily than an attribute with a smaller oval (e.g., bumpiness attribute 501). The weights shown here are examples and, in practice, may be different. Further, as RSMS 101 may receive sensor data over time, the weights for one or more attributes may change over time, as well as raw values or other metrics associated with such attributes.

Bumpiness attribute 501 for a given road segment 301 may be based on, for example, sensor data collected by UEs 103, vehicles 105, or other devices or systems traveling along road segment 301. Such sensor data may include data from accelerometers or other sensors capable of measuring magnitude and/or directionality of acceleration. In some embodiments, RSMS 101 may identify a measure of bumpiness of road segment 301 based on relatively large (e.g., exceeding a threshold magnitude), brief (e.g., less than a threshold duration of time) measures of acceleration in an upward direction.

In some embodiments, bumpiness may be determined according to the following Equations 1 and 2:

$$z [ n ] = {a}_{z} [ n ] * [ 1. , 0 \text{.0} , - 1. ] \qquad ( Equation 1 )$$

$$E ( z [ n ] ) = \frac{1}{N} * {\sum }_{1}^{N} \vert {z [ n ]}^{2} \qquad ( Equation 2 )$$

In Equation 1, z[n] represents the finite difference derivative of vertical acceleration (e.g., a z-component) from a particular sensor sample a_{z}[n], and [1.0, 0.0, −1.0] may be a linear differentiation filter. In Equation 2, E(z[n]) represents the energy of the derivative z[n], and N represents a quantity of samples. In some embodiments, if E(z[n]) exceeds a threshold energy, RSMS 101 may classify a particular road segment 301 as “bumpy.” Additionally, or alternatively, RSMS 101 may maintain a bumpiness score or measure of bumpiness that reflects a magnitude of E(z[n]) and/or indicates road bumpiness in some other way.

Road work attribute 503 may indicate the presence of road work, construction zones, or the like. For example, RSMS 101 may receive visual data (e.g., from UEs 103, vehicles 105, cameras 107, etc.) depicting road construction signs, cones, heavy machinery, and/or other features associated with road work or construction zones. In some embodiments, RSMS 101 and/or some other suitable devices or systems may perform image and/or video recognition in order to identify such features. In some embodiments, RSMS 101 may receive information from information repository 109, indicating that road work or construction zones are present on a particular road segment 301.

Crash attribute 505 may indicate the incidence of crashes or other types of events. For example, RSMS 101 may receive visual data depicting crashes, may identify crashes based on accelerometer data, and/or otherwise detect crashes based on sensor data. Additionally, or alternatively, RSMS 101 may receive statistical information from information repository 109 indicating the occurrence of crashes at a particular road segment 301. In some embodiments, as discussed below, crash information may be a factor based on which one or more other attributes are weighted in the determination of road segment safety score 515.

Soft edges attribute 507 for a given road segment 301 may indicate the incidence of soft edges on road segment 301, such as gravel on the edges of road segment 301, sloped edges of road segment 301, or the like. In some embodiments, soft edges may be detected based on visual data, such as images and/or video collected by UEs 103, cameras 107, vehicles 105, and/or other sources. For example, road signs may include lettering or wording such as “soft edges,” “shoulder drop off,” “soft shoulder,” or the like. Additionally, or alternatively, road signs may include iconography depicting soft edges. RSMS 101 may perform image and/or video recognition techniques to identify such road signs, and/or to visually identify soft edges themselves on road segment 301.

Slipperiness attribute 509 may indicate how slippery a given road segment 301 is at a given time. RSMS 101 may, in some embodiments, determine slipperiness based on visual data, gyroscope data, and/or other suitable data. For example, RSMS 101 may identify skidding, sliding, etc. of a particular vehicle 105 based on gyroscope data and/or computations performed thereon. In some embodiments, Equation 3 may be used to identify a measure S of skidding of vehicle 105, based on gyroscope data associated with vehicle 105.

S=∫|hpf(g_{yaw}(t))|dt (Equation 3)

In Equation 3, g_{yaw}(t) represents a yaw axis of a gyroscope reading, and hpf represents a high-pass filter function to eliminate lower frequency yaw readings, which may be associated with turns and other operations of vehicle 105 that are not associated with skids. In some embodiments, if S exceeds a threshold, RSMS 101 may identify road segment 301 as “slippery.” Additionally, or alternatively, RSMS 101 may maintain a measure of slipperiness, based on S, for road segment 301 in safety model 500 associated with road segment 301.

Speed bump attribute 511 associated with a given road segment 301 may indicate the presence of speed bumps on road segment 301. In some embodiments, speed bump attribute 511 may be determined based on image and/or video recognition of visual data depicting speed bumps on road segment 301. Additionally, or alternatively, speed bump attribute 511 may be determined based on accelerometer data associated with UEs 103 and/or vehicles 105 that travel along road segment 301. For example, Equations 4 and 5 may be used to determine speed bump attribute 511, where the variables in these equations are similar to the variables discussed above with respect to Equations 1 and 2.

z[n]=a_{z}[n]²−a_{z}[n−1]*a_{z}[n+1] (Equation 4)

zₘₐₓ=maxₙ(z[n]) (Equation 5)

If zₘₐₓ exceeds a threshold, RSMS 101 may identify that road segment 301 includes one or more speed bumps. Additionally, or alternatively, RSMS 101 may maintain one or more measures of detected speed bumps (e.g., computed values of zₘₐₓ) for road segment 301 in safety model 500 associated with road segment 301.

Road width attribute 513 associated with a given road segment 301 may indicate a width of road segment 301, and/or a binary indicator of whether the width of road segment 301 exceeds a threshold width. In some embodiments, road width attribute 513 may be based on visual data (e.g., performing a measuring operation on visual depicting road segment 301 to identify the width of road segment 301), statistical data (e.g., as received from information repository 109), and/or may be determined in some other suitable manner.

In some embodiments, one or more attributes 510-513 may be associated with a temporal element, such as an expiration or other duration. For example, road work attribute 503 may be associated with a particular duration, such as twelve hours. For example, when detecting the incidence of road work on road segment 301, RSMS 101 may determine, estimate, etc. that the road work will be present for twelve hours from the time the road work was initially identified, from the last time the road work was identified, and/or based on some other reference time. As another example, slipperiness attribute 509 may be associated with a different duration, such as two hours. For example, when detecting the incidence of slipperiness on road segment 301, RSMS 101 may determine, estimate, etc. that the slipperiness will be present for two hours from the time the slipperiness was initially identified, from the last time the slipperiness was identified, and/or based on some other reference time.

In some embodiments, the durations, expirations, etc. may be determined or modified based on other sources of data. For example, RSMS 101 may receive (e.g., from information repository 109) information indicating the incidence of rain, and/or an expected stop time associated with the rain. In some embodiments, RSMS 101 may determine that the duration associated with slipperiness attribute 509 may begin at or about the expected start time of the rain, may end at or about the expected stop time of the rain, etc. In some embodiments, some attributes may not have durations associated with them, such as soft edges attribute 507, speed bump attribute 511, and/or road width attribute 513, as such attributes may be unlikely to change.

RSMS 101 may determine road segment safety score 515 for road segment 301 based on some or all of attributes 501-513. For example, RSMS 101 may determine one or more scores for each respective attribute 501-513, and may combine the scores to generate road segment safety score 515. In some embodiments, RSMS 101 may average the scores associated with each attribute 501-513, and/or may perform some other computation on the scores for attributes 501-513 to compute road segment safety score 515. In some embodiments, as discussed above, RSMS 101 may determine road segment safety score 515 further based on weights respectively associated with attributes 501-513. When a given attribute expires (e.g., as discussed above), the weight associated with the attribute may be reduced or eliminated, such that road segment safety score 515 is less heavily based on the attribute than prior to the expiration. In some situations, a given road segment 301 may not be associated with any one of attributes 501-513 (e.g., may not have bumps, may not have road work, may not be slippery, etc.). In such situations, the road segment safety score 515 for the given road segment 301 may be set to a “default” or “initial” value, such as 0, 1, or some other suitable value.

In some embodiments, the weights for a particular attribute may be based on a correlation of each attribute to the incidence of crashes, and/or to one or more other attributes. For example, as shown in FIG. 6, RSMS 101 may identify, maintain, etc. multiple instances of bumpiness attribute 501 (e.g., bumpiness attribute 501-1, bumpiness attribute 501-2, and bumpiness attribute 501-3). Each instance of bumpiness attribute 501 may correspond to a particular road segment 301 (e.g., different road segments 301), and/or to different times (e.g., different times associated with the same road segment 301, and/or different times associated with different road segments 301).

Further, RSMS 101 may identify multiple instances of crash attribute 505 associated with the same times and/or road segments 301 as the instances of bumpiness attribute 501. For example, crash attribute 505-1 may correspond to the same road segment 301 as bumpiness attribute 501-1, crash attribute 505-2 may correspond to the same road segment 301 as bumpiness attribute 501-2, and crash attribute 505-3 may correspond to the same road segment 301 as bumpiness attribute 501-3. While shown in the context of a correlation between bumpiness attribute 501 and crash attribute 505, in some embodiments, RSMS 101 may identify correlations between multiple attributes and crash attribute 505.

For example, RSMS 101 may identify, based on the instances of bumpiness attribute 501 and crash attribute 505, that a relatively high correlation exists between high measures of bumpiness and a high incidence of crashes. As such, bumpiness attribute weight 601, associated with bumpiness attribute 501 (e.g., based on which road segment safety score 515 may be computed) may be relatively high. In a multi-feature analysis, RSMS 101 may further identify that other attributes (e.g., other than bumpiness attribute 501) have a lower correlation to the incidence of crashes, which may also indicate that bumpiness attribute weight 601 may be relatively high. In this manner, individual attributes may be weighted based on their correlation to crashes, which may imply or reflect causation between such attributes and crashes. As such, road segment safety scores 515 may more heavily reflect attributes that have a higher correlation to crashes, thus providing a more useful metric by which navigation instructions may be determined, traffic signals may be controlled, and/or by which overall road safety may further be improved.

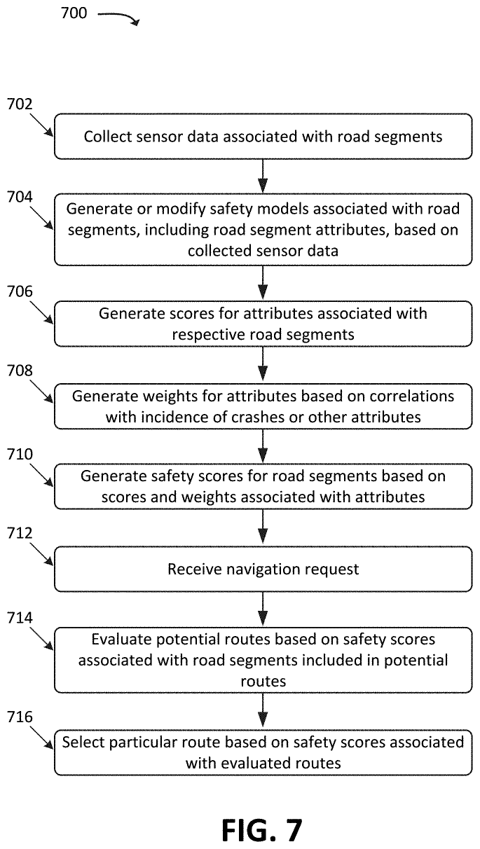

FIG. 7 illustrates an example process 700 for generating safety scores for road segments and providing navigation instruction based on the generated safety scores. In some embodiments, some or all of process 700 may be performed by RSMS 101. In some embodiments, one or more other devices may perform some or all of process 700 (e.g., in concert with, and/or in lieu of, RSMS 101).

As shown, process 700 may include collecting (at 702) sensor data associated with a set of road segments 301 associated with one or more roads 303. As noted above, such sensor data may be received from devices or systems that are located on and/or that travel on road segments 301, such as UEs 103, vehicles 105, and/or cameras 107. In some embodiments, the sensor data may be received from devices or systems that are not located on or that do not travel on road segments 301, but are otherwise able to collect sensor data that is pertinent to or is associated with road segments 301, such as cameras 107 that are pointed at road segments 301. Additionally, or alternatively, RSMS 101 may receive data from one or more information repositories 109, which may include annotations or other indications that such data is associated with particular road segments 301. In some embodiments, the received (at 702) data may include a timestamp or other indication of time at which the data was collected. As discussed above, the timestamps may be used when determining whether the data has expired or not (e.g., when such data is associated with transient conditions). As also discussed above, RSMS 101 may collect the sensor data via “push” or “pull” mechanisms, and may collect the sensor data over time such that RSMS 101 is able to maintain up-to-date information regarding road segments 301 in real time or near-real time.

Process 700 may further include generating or modifying (at 704) one or more safety models associated with the road segments 301 for which sensor data was collected. For example, as discussed above, RSMS 101 may determine attributes associated with road segments 301, such as bumpiness attribute 501, road work attribute 503, crash attribute 505, soft edges attribute 507, slipperiness attribute 509, speed bump attribute 511, road width attribute 513, and/or one or more other attributes. The attributes may be determined based on the sensor data received (at 702) using the techniques described above and/or other suitable techniques.

Process 700 may additionally include generating (at 706) scores for the attributes associated with respective road segments 301. For example, RSMS 101 may generate scores indicating a magnitude or other measure associated with each attribute determined with respect to road segments 301. For example, a first road segment 301 with no bumps may be associated with a score of 0 (or some other minimal score) for bumpiness attribute 501 associated with the first road segment 301, a second road segment 301 with a moderate amount of bumps may be associated with a score of 50 (or some other moderate score) for bumpiness attribute 501 associated with the second road segment 301, and a third road segment 301 with a relatively large amount of bumps may be associated with a score of 90 (or some other relatively high score) for bumpiness attribute 501 associated with the third road segment 301. In some embodiments, the score for a given attribute may be a binary score, such as a score of 0 (or some other suitable binary indicator) when the amount or magnitude associated with the attribute is below a threshold, and a score of 1 (or some other suitable binary indicator) when the amount or magnitude associated with the attribute is above a threshold.

Process 700 may also include generating (at 708) weights for attributes based on correlations of respective attributes with crashes and/or other attributes. For example, as discussed above with respect to FIG. 6, RSMS 101 may correlate particular attributes of one or more road segments 301 (e.g., the same attribute across multiple road segments 301 and/or multiple time periods for the same or different road segments 301) to crash attribute 505 and/or other attributes. In this manner, each particular attribute may be weighted by correlation to the particular attribute and the incidence of crashes. Thus, an attribute with a higher weight may be more likely to cause or otherwise be associated with vehicular crashes or other types of incidents.

Process 700 may further include generating (at 710) safety scores for road segments 301 based on the scores and weights associated with respective road segments 301. For example, RSMS 101 may combine the scores for the attributes identified with respect to road segments 301, such as by summing the scores for the attributes, averaging the scores for the attributes, and/or performing one or more other functions or computations to generate the safety score for road segment 301. In some embodiments, RSMS 101 may utilize the weights when combining the scores for the attributes, such as by multiplying each attribute score by the weight for that attribute and/or otherwise using the weights when generating the safety score for road segment 301.

Process 700 may additionally include receiving (at 712) a navigation request. For example, RSMS 101 and/or some other device or system communicatively coupled to RSMS 101 may receive a navigation request specifying a starting point and a destination. For example, a device or system that processes navigation requests and provides navigation directions in response to such requests may receive (at 712) the navigation request. In some embodiments, such devices or systems may receive some or all of the generated (at 710) safety scores associated with one or more road segments 301. RSMS 101 and/or the other device or system may identify potential routes, including particular road segments 301, that may be candidates for how to reach the destination from the starting point.

Process 700 may also include evaluating (at 714) potential routes based on safety scores associated with road segments 301 included in the potential routes. For example, RSMS 101 may combine the safety scores for the road segments 301 included in each route to identify a safety score for each potential route. In some embodiments, combining the safety scores for component road segments 301 of a route may include summing the safety scores for the component road segments 301, averaging the safety scores for the component road segments 301, and/or performing some other suitable computation based on the safety scores for the component road segments 301 of the route.

In some embodiments, after receiving (at 712) the navigation request, RSMS 101 may generate and/or update previously generated (at 710) safety scores. In some embodiments, in embodiments where a device or system other than RSMS 101 generates the safety scores, the other device or system may request updated safety scores from RSMS 101 for safety scores associated with the potential routes (evaluated at 714).

In some embodiments, combining the safety scores may include weighting the safety scores for particular component road segments based on a quantity of road conditions associated with the road segment 301. For example, if the bumpiness attribute for the particular road segment 301 exceeds a threshold value at 3 locations along the particular road segment 301, this may indicate 3 bumps along road segment 301, and the safety score associated with the particular road segment 301 may be weighted based on the 3 occurrences of bumps along road segment 301. As another example, the safety score for a particular road segment 301 may be weighted based on a quantity of crashes associated with the particular road segment 301. For example, a particular road segment 301 with a relatively high number of crashes over a given time period may be associated with a higher weight than a different road segment 301 with a relatively lower number of crashes over the given time period. In some embodiments, road segments 301 may be weighted based on one or more other attributes associated with the road segments 301 (e.g., based on magnitude and/or quantity of occurrences of particular attributes or events).

Process 700 may further include selecting (at 716) a particular route based on the safety scores associated with the evaluated routes. For example, RSMS 101 may identify a route with a lowest safety score as the selected route. In some embodiments, RSMS 101 may select the particular route based on one or more other factors, such as travel times associated with the routes, user preferences, etc. For example, RSMS 101 may generate a travel time-safety combined score for a given route based on travel time of the route and the safety score of the route. As a result, in some circumstances, the selected route may not be the route with the highest (e.g., safest) safety score. RSMS 101 may further provide the selected particular route to a source from which the navigation request was received. In some embodiments, RSMS 101 may perform one or more other actions (e.g., in addition to, or in lieu of, providing navigation instructions) based on safety scores. For example, RSMS 101 may modify parameters of configurable traffic fixtures such as timings of street lights, lettering or wording of signs with configurable lettering or wording, and/or perform other suitable actions.

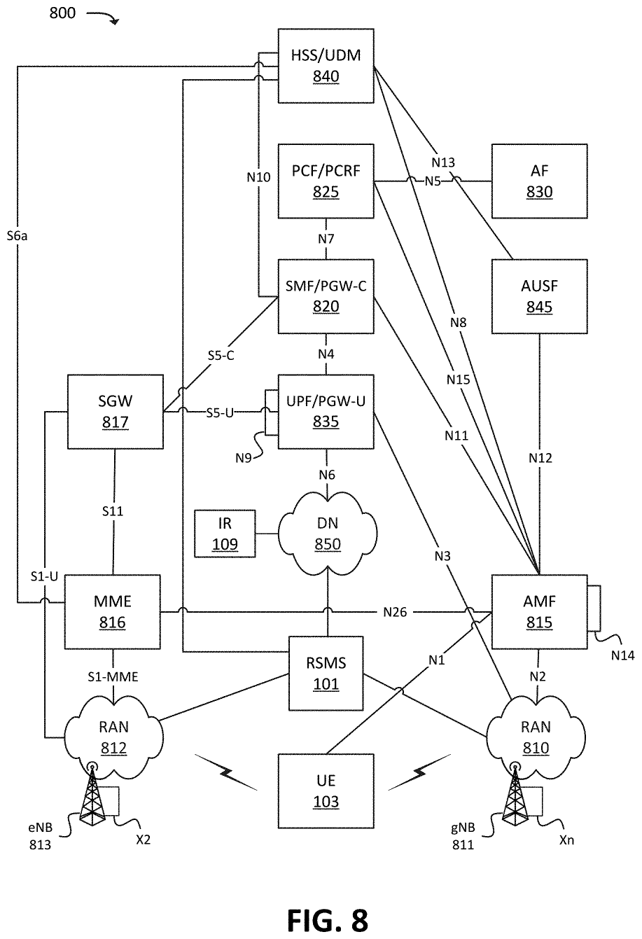

FIG. 8 illustrates an example environment 800, in which one or more embodiments may be implemented. In some embodiments, environment 800 may correspond to a Fifth Generation (“5G”) network, and/or may include elements of a 5G network. In some embodiments, environment 800 may correspond to a 5G Non-Standalone (“NSA”) architecture, in which a 5G radio access technology (“RAT”) may be used in conjunction with one or more other RATs (e.g., a Long-Term Evolution (“LTE”) RAT), and/or in which elements of a 5G core network may be implemented by, may be communicatively coupled with, and/or may include elements of another type of core network (e.g., an evolved packet core (“EPC”)). As shown, environment 800 may include UE 801, RAN 810 (which may include one or more Next Generation Node Bs (“gNBs”) 811), RAN 812 (which may include one or more one or more evolved Node Bs (“eNBs”) 813), and various network functions such as Access and Mobility Management Function (“AMF”) 815, Mobility Management Entity (“MME”) 816, Serving Gateway (“SGW”) 817, Session Management Function (“SMF”)/Packet Data Network (“PDN”) Gateway (“PGW”)-Control plane function (“PGW-C”) 820, Policy Control Function (“PCF”)/Policy Charging and Rules Function (“PCRF”) 825, Application Function (“AF”) 830, User Plane Function (“UPF”)/PGW-User plane function (“PGW-U”) 835, Home Subscriber Server (“HSS”)/Unified Data Management (“UDM”) 840, and Authentication Server Function (“AUSF”) 845. Environment 800 may also include one or more networks, such as Data Network (“DN”) 850. Environment 800 may include one or more additional devices or systems communicatively coupled to one or more networks (e.g., DN 850), such as RSMS 101 and/or information repository 109, which may each include one or more devices or systems that perform some or all of the operations described above.

The example shown in FIG. 8 illustrates one instance of each network component or function (e.g., one instance of SMF/PGW-C 820, PCF/PCRF 825, UPF/PGW-U 835, HSS/UDM 840, and/or AUSF 845). In practice, environment 800 may include multiple instances of such components or functions. For example, in some embodiments, environment 800 may include multiple “slices” of a core network, where each slice includes a discrete set of network functions (e.g., one slice may include a first instance of SMF/PGW-C 820, PCF/PCRF 825, UPF/PGW-U 835, HSS/UDM 840, and/or AUSF 845, while another slice may include a second instance of SMF/PGW-C 820, PCF/PCRF 825, UPF/PGW-U 835, HSS/UDM 840, and/or AUSF 845). The different slices may provide differentiated levels of service, such as service in accordance with different Quality of Service (“QoS”) parameters.

The quantity of devices and/or networks, illustrated in FIG. 8, is provided for explanatory purposes only. In practice, environment 800 may include additional devices and/or networks, fewer devices and/or networks, different devices and/or networks, or differently arranged devices and/or networks than illustrated in FIG. 8. For example, while not shown, environment 800 may include devices that facilitate or enable communication between various components shown in environment 800, such as routers, modems, gateways, switches, hubs, etc. Alternatively, or additionally, one or more of the devices of environment 800 may perform one or more network functions described as being performed by another one or more of the devices of environment 800. Devices of environment 800 may interconnect with each other and/or other devices via wired connections, wireless connections, or a combination of wired and wireless connections. In some implementations, one or more devices of environment 800 may be physically integrated in, and/or may be physically attached to, one or more other devices of environment 800.

UE 801 may include a computation and communication device, such as a wireless mobile communication device that is capable of communicating with RAN 810, RAN 812, and/or DN 850. UE 801 may be, or may include, a radiotelephone, a personal communications system (“PCS”) terminal (e.g., a device that combines a cellular radiotelephone with data processing and data communications capabilities), a personal digital assistant (“PDA”) (e.g., a device that may include a radiotelephone, a pager, Internet/intranet access, etc.), a smart phone, a laptop computer, a tablet computer, a camera, a personal gaming system, an IoT device (e.g., a sensor, a smart home appliance, or the like), a wearable device, an Internet of Things (“IoT”) device, a Machine-to-Machine (“M2M”) device, or another type of mobile computation and communication device. UE 801 may send traffic to and/or receive traffic (e.g., user plane traffic) from DN 850 via RAN 810, RAN 812, and/or UPF/PGW-U 835.

RAN 810 may be, or may include, a 5G RAN that includes one or more base stations (e.g., one or more gNBs 811), via which UE 801 may communicate with one or more other elements of environment 800. UE 801 may communicate with RAN 810 via an air interface (e.g., as provided by gNB 811). For instance, RAN 810 may receive traffic (e.g., voice call traffic, data traffic, messaging traffic, signaling traffic, etc.) from UE 801 via the air interface, and may communicate the traffic to UPF/PGW-U 835, and/or one or more other devices or networks. Similarly, RAN 810 may receive traffic intended for UE 801 (e.g., from UPF/PGW-U 835, AMF 815, and/or one or more other devices or networks) and may communicate the traffic to UE 801 via the air interface.

RAN 812 may be, or may include, a LTE RAN that includes one or more base stations (e.g., one or more eNBs 813), via which UE 801 may communicate with one or more other elements of environment 800. UE 801 may communicate with RAN 812 via an air interface (e.g., as provided by eNB 813). For instance, RAN 810 may receive traffic (e.g., voice call traffic, data traffic, messaging traffic, signaling traffic, etc.) from UE 801 via the air interface, and may communicate the traffic to UPF/PGW-U 835, and/or one or more other devices or networks. Similarly, RAN 810 may receive traffic intended for UE 801 (e.g., from UPF/PGW-U 835, SGW 817, and/or one or more other devices or networks) and may communicate the traffic to UE 801 via the air interface.

AMF 815 may include one or more devices, systems, Virtualized Network Functions (“VNFs”), etc., that perform operations to register UE 801 with the 5G network, to establish bearer channels associated with a session with UE 801, to hand off UE 801 from the 5G network to another network, to hand off UE 801 from the other network to the 5G network, manage mobility of UE 801 between RANs 810 and/or gNBs 811, and/or to perform other operations. In some embodiments, the 5G network may include multiple AMFs 815, which communicate with each other via the N14 interface (denoted in FIG. 8 by the line marked “N14” originating and terminating at AMF 815).

MME 816 may include one or more devices, systems, VNFs, etc., that perform operations to register UE 801 with the EPC, to establish bearer channels associated with a session with UE 801, to hand off UE 801 from the EPC to another network, to hand off UE 801 from another network to the EPC, manage mobility of UE 801 between RANs 812 and/or eNBs 813, and/or to perform other operations.

SGW 817 may include one or more devices, systems, VNFs, etc., that aggregate traffic received from one or more eNBs 813 and send the aggregated traffic to an external network or device via UPF/PGW-U 835. Additionally, SGW 817 may aggregate traffic received from one or more UPF/PGW-Us 835 and may send the aggregated traffic to one or more eNBs 813. SGW 817 may operate as an anchor for the user plane during inter-eNB handovers and as an anchor for mobility between different telecommunication networks or RANs (e.g., RANs 810 and 812).

SMF/PGW-C 820 may include one or more devices, systems, VNFs, etc., that gather, process, store, and/or provide information in a manner described herein. SMF/PGW-C 820 may, for example, facilitate the establishment of communication sessions on behalf of UE 801. In some embodiments, the establishment of communications sessions may be performed in accordance with one or more policies provided by PCF/PCRF 825.

PCF/PCRF 825 may include one or more devices, systems, VNFs, etc., that aggregate information to and from the 5G network and/or other sources. PCF/PCRF 825 may receive information regarding policies and/or subscriptions from one or more sources, such as subscriber databases and/or from one or more users (such as, for example, an administrator associated with PCF/PCRF 825).

AF 830 may include one or more devices, systems, VNFs, etc., that receive, store, and/or provide information that may be used in determining parameters (e.g., quality of service parameters, charging parameters, or the like) for certain applications.

UPF/PGW-U 835 may include one or more devices, systems, VNFs, etc., that receive, store, and/or provide data (e.g., user plane data). For example, UPF/PGW-U 835 may receive user plane data (e.g., voice call traffic, data traffic, etc.), destined for UE 801, from DN 850, and may forward the user plane data toward UE 801 (e.g., via RAN 810, SMF/PGW-C 820, and/or one or more other devices). In some embodiments, multiple UPFs 835 may be deployed (e.g., in different geographical locations), and the delivery of content to UE 801 may be coordinated via the N9 interface (e.g., as denoted in FIG. 8 by the line marked “N9” originating and terminating at UPF/PGW-U 835). Similarly, UPF/PGW-U 835 may receive traffic from UE 801 (e.g., via RAN 810, SMF/PGW-C 820, and/or one or more other devices), and may forward the traffic toward DN 850. In some embodiments, UPF/PGW-U 835 may communicate (e.g., via the N4 interface) with SMF/PGW-C 820, regarding user plane data processed by UPF/PGW-U 835.

HSS/UDM 840 and AUSF 845 may include one or more devices, systems, VNFs, etc., that manage, update, and/or store, in one or more memory devices associated with AUSF 845 and/or HSS/UDM 840, profile information associated with a subscriber. AUSF 845 and/or HSS/UDM 840 may perform authentication, authorization, and/or accounting operations associated with the subscriber and/or a communication session with UE 801.

DN 850 may include one or more wired and/or wireless networks. For example, DN 850 may include an Internet Protocol (“IP”)-based PDN, a wide area network (“WAN”) such as the Internet, a private enterprise network, and/or one or more other networks. UE 801 may communicate, through DN 850, with data servers, other UEs 801, and/or to other servers or applications that are coupled to DN 850. DN 850 may be connected to one or more other networks, such as a public switched telephone network (“PSTN”), a public land mobile network (“PLMN”), and/or another network. DN 850 may be connected to one or more devices, such as content providers, applications, web servers, and/or other devices, with which UE 801 may communicate.

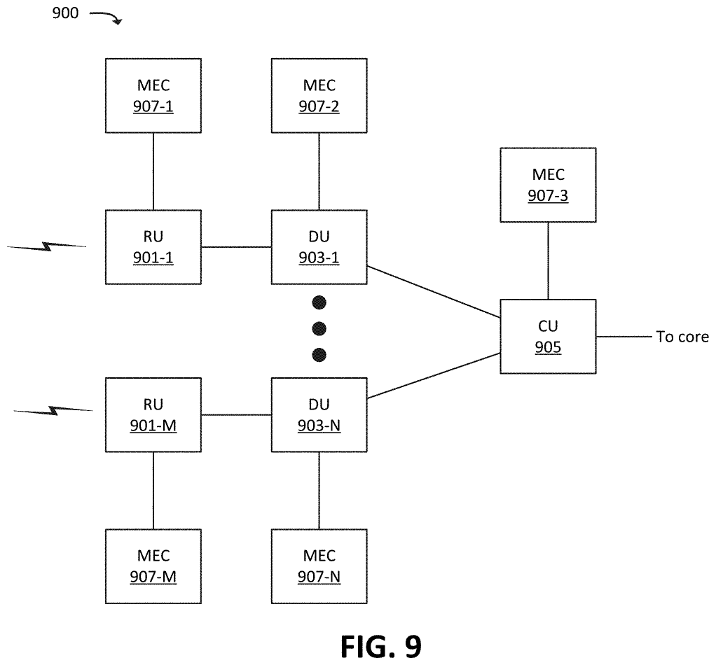

FIG. 9 illustrates an example Distributed Unit (“DU”) network 900, which may be included in and/or implemented by one or more RANs (e.g., RAN 810, RAN 812, or some other RAN). In some embodiments, a particular RAN may include one DU network 900. In some embodiments, a particular RAN may include multiple DU networks 900. In some embodiments, DU network 900 may correspond to a particular gNB 811 of a 5G RAN (e.g., RAN 810). In some embodiments, DU network 900 may correspond to multiple gNBs 811. In some embodiments, DU network 900 may correspond to one or more other types of base stations of one or more other types of RANs. As shown, DU network 900 may include Central Unit (“CU”) 905, one or more Distributed Units (“DUs”) 903-1 through 903-N (referred to individually as “DU 903,” or collectively as “DUs 903”), and one or more Radio Units (“RUs”) 901-1 through 901-M (referred to individually as “RU 901,” or collectively as “RUs 901”).

CU 905 may communicate with a core of a wireless network (e.g., may communicate with one or more of the devices or systems described above with respect to FIG. 8, such as AMF 815 and/or UPF/PGW-U 835). In the uplink direction (e.g., for traffic from UEs 801 to a core network), CU 905 may aggregate traffic from DUs 903, and forward the aggregated traffic to the core network. In some embodiments, CU 905 may receive traffic according to a given protocol (e.g., Radio Link Control (“RLC”)) from DUs 903, and may perform higher-layer processing (e.g., may aggregate/process RLC packets and generate Packet Data Convergence Protocol (“PDCP”) packets based on the RLC packets) on the traffic received from DUs 903.

In accordance with some embodiments, CU 905 may receive downlink traffic (e.g., traffic from the core network) for a particular UE 801, and may determine which DU(s) 903 should receive the downlink traffic. DU 903 may include one or more devices that transmit traffic between a core network (e.g., via CU 905) and UE 801 (e.g., via a respective RU 901). DU 903 may, for example, receive traffic from RU 901 at a first layer (e.g., physical (“PHY”) layer traffic, or lower PHY layer traffic), and may process/aggregate the traffic to a second layer (e.g., upper PHY and/or RLC). DU 903 may receive traffic from CU 905 at the second layer, may process the traffic to the first layer, and provide the processed traffic to a respective RU 901 for transmission to UE 801.

RU 901 may include hardware circuitry (e.g., one or more RF transceivers, antennas, radios, and/or other suitable hardware) to communicate wirelessly (e.g., via an RF interface) with one or more UEs 801, one or more other DUs 903 (e.g., via RUs 901 associated with DUs 903), and/or any other suitable type of device. In the uplink direction, RU 901 may receive traffic from UE 801 and/or another DU 903 via the RF interface and may provide the traffic to DU 903. In the downlink direction, RU 901 may receive traffic from DU 903, and may provide the traffic to UE 801 and/or another DU 903.

RUs 901 may, in some embodiments, be communicatively coupled to one or more Multi-Access/Mobile Edge Computing (“MEC”) devices, referred to sometimes herein simply as “MECs” 907. For example, RU 901-1 may be communicatively coupled to MEC 907-1, RU 901-M may be communicatively coupled to MEC 907-M, DU 903-1 may be communicatively coupled to MEC 907-2, DU 903-N may be communicatively coupled to MEC 907-N, CU 905 may be communicatively coupled to MEC 907-3, and so on. MECs 907 may include hardware resources (e.g., configurable or provisionable hardware resources) that may be configured to provide services and/or otherwise process traffic to and/or from UE 801, via a respective RU 901.

For example, RU 901-1 may route some traffic, from UE 801, to MEC 907-1 instead of to a core network (e.g., via DU 903 and CU 905). MEC 907-1 may process the traffic, perform one or more computations based on the received traffic, and may provide traffic to UE 801 via RU 901-1. In this manner, ultra-low latency services may be provided to UE 801, as traffic does not need to traverse DU 903, CU 905, and an intervening backhaul network between DU network 900 and the core network. In some embodiments, MEC 907 may include, and/or may implement, some or all of the functionality described above with respect to RSMS 101.

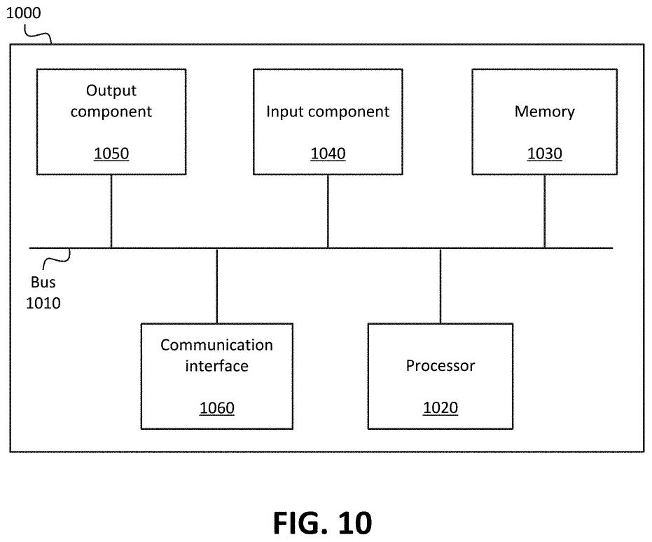

FIG. 10 illustrates example components of device 1000. One or more of the devices described above may include one or more devices 1000. Device 1000 may include bus 1010, processor 1020, memory 1030, input component 1040, output component 1050, and communication interface 1060. In another implementation, device 1000 may include additional, fewer, different, or differently arranged components.

Bus 1010 may include one or more communication paths that permit communication among the components of device 1000. Processor 1020 may include a processor, microprocessor, or processing logic that may interpret and execute instructions. Memory 1030 may include any type of dynamic storage device that may store information and instructions for execution by processor 1020, and/or any type of non-volatile storage device that may store information for use by processor 1020.

Input component 1040 may include a mechanism that permits an operator to input information to device 1000 and/or other receives or detects input from a source external to 1040, such as a touchpad, a touchscreen, a keyboard, a keypad, a button, a switch, a microphone or other audio input component, etc. In some embodiments, input component 1040 may include, or may be communicatively coupled to, one or more sensors, such as a motion sensor (e.g., which may be or may include a gyroscope, accelerometer, or the like), a location sensor (e.g., a Global Positioning System (“GPS”)-based location sensor or some other suitable type of location sensor or location determination component), a thermometer, a barometer, and/or some other type of sensor. Output component 1050 may include a mechanism that outputs information to the operator, such as a display, a speaker, one or more light emitting diodes (“LEDs”), etc.

Communication interface 1060 may include any transceiver-like mechanism that enables device 1000 to communicate with other devices and/or systems. For example, communication interface 1060 may include an Ethernet interface, an optical interface, a coaxial interface, or the like. Communication interface 1060 may include a wireless communication device, such as an infrared (“IR”) receiver, a Bluetooth® radio, or the like. The wireless communication device may be coupled to an external device, such as a remote control, a wireless keyboard, a mobile telephone, etc. In some embodiments, device 1000 may include more than one communication interface 1060. For instance, device 1000 may include an optical interface and an Ethernet interface.

Device 1000 may perform certain operations relating to one or more processes described above. Device 1000 may perform these operations in response to processor 1020 executing software instructions stored in a computer-readable medium, such as memory 1030. A computer-readable medium may be defined as a non-transitory memory device. A memory device may include space within a single physical memory device or spread across multiple physical memory devices. The software instructions may be read into memory 1030 from another computer-readable medium or from another device. The software instructions stored in memory 1030 may cause processor 1020 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations.

For example, while series of blocks and/or signals have been described above (e.g., with regard to FIGS. 1-7), the order of the blocks and/or signals may be modified in other implementations. Further, non-dependent blocks and/or signals may be performed in parallel. Additionally, while the figures have been described in the context of particular devices performing particular acts, in practice, one or more other devices may perform some or all of these acts in lieu of, or in addition to, the above-mentioned devices.

The actual software code or specialized control hardware used to implement an embodiment is not limiting of the embodiment. Thus, the operation and behavior of the embodiment has been described without reference to the specific software code, it being understood that software and control hardware may be designed based on the description herein.

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

Further, while certain connections or devices are shown, in practice, additional, fewer, or different, connections or devices may be used. Furthermore, while various devices and networks are shown separately, in practice, the functionality of multiple devices may be performed by a single device, or the functionality of one device may be performed by multiple devices. Further, multiple ones of the illustrated networks may be included in a single network, or a particular network may include multiple networks. Further, while some devices are shown as communicating with a network, some such devices may be incorporated, in whole or in part, as a part of the network.

To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

What is claimed is:

1. A device, comprising:
one or more processors configured to:
identify a plurality of attributes associated with a plurality of road segments;
generate a safety score for each respective road segment of the plurality of road segments based on the attributes associated with the respective road segment;
receive a navigation request from a starting point to a destination;
identify a plurality of routes from the starting point to the destination, the routes each including one or more road segments;
determine a safety score for each respective route, of the plurality of routes, based on the safety scores associated with the road segments included in the respective route;
select a particular route from the plurality of routes based on the determined safety scores for the plurality of routes; and
present, in response to the navigation request, the selected particular route.

2. The device of claim 1, wherein generating the safety score for a particular road segment, of the plurality of road segments, includes:
generating scores for each attribute of the plurality of attributes associated with the road segment; and
combining the generated scores for each attribute of the plurality of attributes to generate the safety score for the particular road segment.

3. The device of claim 2, wherein generating the safety score for the particular road segment further includes:
weighting a particular score for a particular attribute of the plurality of attributes based on a correlation between the particular attribute and at least one other attribute,
wherein combining the generated scores for each attribute includes combining the weighted particular score for the particular attribute with one or more scores for one or more other attributes of the plurality of attributes.

4. The device of claim 1, wherein generating the safety score for a particular road segment, of the plurality of road segments, includes:
determining a correlation between each attribute, of the plurality of attributes, and a respective measure of incidence of vehicular crashes; and
generating the safety score further based on the correlation between each attribute with the respective measure of incidence of vehicular crashes.

5. The device of claim 1, wherein the one or more processors are further configured to:
determine a travel time for each respective route of the plurality of routes,
wherein selecting the particular route from the plurality of routes is further based on the determined travel times for the plurality of routes.

6. The device of claim 5, wherein the selected route is not associated with a highest safety score of the determined safety scores associated with the plurality of routes.

7. The device of claim 1, wherein the one or more processors are further configured to:
identify a particular configurable traffic fixture associated with a particular road segment of the plurality of road segments; and
modify one or more parameters of the configurable traffic fixture based on the determined safety score associated with the particular road segment.

8. A non-transitory computer-readable medium, storing a plurality of processor-executable instructions to:
identify a plurality of attributes associated with a plurality of road segments;
generate a safety score for each respective road segment of the plurality of road segments based on the attributes associated with the respective road segment;
receive a navigation request from a starting point to a destination;
identify a plurality of routes from the starting point to the destination, the routes each including one or more road segments;
determine a safety score for each respective route, of the plurality of routes, based on the safety scores associated with the road segments included in the respective route;
select a particular route from the plurality of routes based on the determined safety scores for the plurality of routes; and
present, in response to the navigation request, the selected particular route.

9. The non-transitory computer-readable medium of claim 8, wherein generating the safety score for a particular road segment, of the plurality of road segments, includes:
generating scores for each attribute of the plurality of attributes associated with the road segment; and
combining the generated scores for each attribute of the plurality of attributes to generate the safety score for the particular road segment.

10. The non-transitory computer-readable medium of claim 9, wherein generating the safety score for the particular road segment further includes:
weighting a particular score for a particular attribute of the plurality of attributes based on a correlation between the particular attribute and at least one other attribute,
wherein combining the generated scores for each attribute includes combining the weighted particular score for the particular attribute with one or more scores for one or more other attributes of the plurality of attributes.

11. The non-transitory computer-readable medium of claim 8, wherein generating the safety score for a particular road segment, of the plurality of road segments, includes:
determining a correlation between each attribute, of the plurality of attributes, and a respective measure of incidence of vehicular crashes; and
generating the safety score further based on the correlation between each attribute with the respective measure of incidence of vehicular crashes.

12. The non-transitory computer-readable medium of claim 8, wherein the plurality of processor-executable instructions further include processor-executable instructions to:
determine a travel time for each respective route of the plurality of routes,
wherein selecting the particular route from the plurality of routes is further based on the determined travel times for the plurality of routes.

13. The non-transitory computer-readable medium of claim 12, wherein the selected route is not associated with a highest safety score of the determined safety scores associated with the plurality of routes.

14. The non-transitory computer-readable medium of claim 8, wherein the plurality of processor-executable instructions further include processor-executable instructions to:
identify a particular configurable traffic fixture associated with a particular road segment of the plurality of road segments; and
modify one or more parameters of the configurable traffic fixture based on the determined safety score associated with the particular road segment.

15. A method, comprising:
identifying a plurality of attributes associated with a plurality of road segments;
generating a safety score for each respective road segment of the plurality of road segments based on the attributes associated with the respective road segment;
receiving a navigation request from a starting point to a destination;
identifying a plurality of routes from the starting point to the destination, the routes each including one or more road segments;
determining a safety score for each respective route, of the plurality of routes, based on the safety scores associated with the road segments included in the respective route;
selecting a particular route from the plurality of routes based on the determined safety scores for the plurality of routes; and
presenting, in response to the navigation request, the selected particular route.

16. The method of claim 15, wherein generating the safety score for a particular road segment, of the plurality of road segments, includes:
generating scores for each attribute of the plurality of attributes associated with the road segment; and
combining the generated scores for each attribute of the plurality of attributes to generate the safety score for the particular road segment.

17. The method of claim 16, wherein generating the safety score for the particular road segment further includes:
weighting a particular score for a particular attribute of the plurality of attributes based on a correlation between the particular attribute and at least one other attribute,
wherein combining the generated scores for each attribute includes combining the weighted particular score for the particular attribute with one or more scores for one or more other attributes of the plurality of attributes.

18. The method of claim 15, wherein generating the safety score for a particular road segment, of the plurality of road segments, includes:
determining a correlation between each attribute, of the plurality of attributes, and a respective measure of incidence of vehicular crashes; and
generating the safety score further based on the correlation between each attribute with the respective measure of incidence of vehicular crashes.

19. The method of claim 15, the method further comprising:
determine a travel time for each respective route of the plurality of routes,
wherein selecting the particular route from the plurality of routes is further based on the determined travel times for the plurality of routes,
wherein the selected route is not associated with a highest safety score of the determined safety scores associated with the plurality of routes.

20. The method of claim 15, the method further comprising:
identifying a particular configurable traffic fixture associated with a particular road segment of the plurality of road segments; and
modifying one or more parameters of the configurable traffic fixture based on the determined safety score associated with the particular road segment.
